(19) United States
(12) Patent Application Publication
(10) Pub. No.: US 2004/0133893 A1
(43) Pub. Date: Jul. 8, 2004

(54) Method and apparatus for managing environment variables in a multithreaded user process

(75) Inventors: Nicholas Carbone, Poughkeepsie, NY (US); Gary R. Dexter, Kingston, NY (US); Christopher A. Robbins, New York, NY (US)

Correspondence Address: William A. Kinnaman, Jr., IBM Corporation - IPLaw Department, 2455 South Road - M/S 386, Poughkeepsie, NY, 12601, US

(73) Assignee: International Business Machines Corporation, Armonk, NY

(21) Appl. No.: 10/338,214

(22) Filed: Jan. 8, 2003

(51) Int. Cl. G06F 9/46

(52) U.S. Cl. 718/107; 718/100

(57) ABSTRACT

A method and apparatus for managing environment variables of a user process in an information handling system having a plurality of simultaneously running threads of execution. Thread-level set and get functions invoked by a subject thread are defined to manage environment variables of the subject thread at the thread level rather than at the process level. In response to a request to set the value of a thread-level environment variable, a thread-level set function determines whether a thread-specific environment has already been created for the subject thread. If so, the set function inserts the thread-level environment variable in the thread-specific environment. Otherwise, the set function creates a thread-specific environment and inserts the thread-level environment variable in the newly created thread-specific environment. In response to a request to obtain the value of a thread-level environment variable, a thread-level get function determines whether a thread-level environment variable has been defined for the subject thread. If so, the get function returns the thread-level environment variable. Otherwise, the get function returns the corresponding process-level environment variable. The thread-level environment created for a subject thread is destroyed when subject thread is terminated.

### BACKGROUND OF THE INVENTION

1. Field of the Invention

This invention relates to a method and apparatus for managing environment variables of a user process in an information handling system having a plurality of simultaneously running threads of execution.

2. Description of the Related Art

Environment variables are strings of the form “name=value”, where name is the name of a particular environment variable and value is the corresponding value. A program environment is maintained as an array of such strings that are made available when a process begins. The general purpose of such environment variables is to modify or customize the dynamic behavior of the programs in which they are used. Although environment variables are not limited to UNIX-based systems, their use in such systems is described in such references as The Single UNIX Specification, Version 2 (1997), published online by The Open Group.

The current C/C++ programming language provides the ability to adjust a program's run-time behavior through the use of environment variables. Environment variables can be set and queried by a programmer via the existing C/C++ library functions setenv( ), putenv( ) and getenv( ), as described, for example, in the IBM publication z/OS C/C++ Run-Time Library Reference, SA22-7821-02 (March 2002), incorporated herein by reference. Environment variables are also often set by end users to be queried by C/C++ applications and utilities, which act differently based upon their values. Thus, in the UNIX System Services component of the IBM z/OS operating system, the shell command env( ) may be used to display or set environment variables for a process, as described at pages 238-239 of the IBM publication z/OS UNIXSystem Services Command Reference, SA22-7802-02 (June 2002), incorporated herein by reference.

The online publication referenced above also describes the standard behavior of threads in UNIX-based environments. Of particular interest to the present invention is the behavior of environment variables across threads within a single process. Currently, environment variables are limited to being maintained at the main, or process-wide, level, and not at the thread level. If a thread does manipulate the value of an environment variable via setenv( ) or putenv( ), the resulting value is propagated back to the main program and any other threads created by the program. In summary, this behavior entails the maintenance of one process-wide environment, such that changes to the environment by one thread are propagated to all other threads within the same process. The problem with such a process-wide environment is that it does not permit certain environment variables to simultaneously have different values in different threads, as would sometimes be desired.

### SUMMARY OF THE INVENTION

The present invention introduces the concept of thread variables. Thread variables work similarly to environment variables, but are maintained at the thread level rather than the process level.

Using either one of two new thread variable functions _settv( ) and _puttv( ), a thread can set the value of an existing environment variable without affecting the variable's value when queried by the thread's parent or sibling threads. Furthermore, the thread can query the thread-level variable value with a new thread variable function _gettv( ). In addition, a thread can always obtain the process-wide value of an environment variable with the getenv( ) function. If the value of an environment variable has not been set at the thread level, _gettv( ) will return the process-level value.

More precisely, the invention contemplates a method and apparatus for managing environment variables in a user process having a plurality of simultaneously running threads of execution. In accordance with the invention, a thread-level environment variable that is defined for a thread and is capable of having a different value for different threads of a user process is stored for each of one or more of such threads of the user process. It is this thread-level environment variable, rather than a process-level environment variable, that is preferentially accessed in response to a request to access a thread-level environment variable of a subject thread.

The thread-level environment variable is stored along with other thread-level environment variables for the same thread in a thread-level environment created for the subject thread. The thread-level environment is created upon the first issuance of a request to set a thread-level variable for the subject thread and is destroyed upon termination of the subject thread.

The request may originate from the subject thread and may specify a name and (for a write request) a value for a thread-level environment variable. As noted above, in a preferred embodiment, three new function calls, _puttv( ), _settv( ) and _gettv( ), are provided as a mechanism for making such requests. These calls are similar to the existing putenv( ), setenv( ) and getenv( ) functions, respectively, but operate at the thread level. A thread makes a _puttv( ) or settv( ) function call to set a thread-level environment variable and makes a _gettv( ) function call to obtain the value of a thread-level environment variable.

In response to a _puttv( ) or _settv( ) function call, a thread-specific environment is created if it has not already been created for the subject thread and the thread-level environment variable specified by the function call is inserted in the thread-specific environment. In response to a _gettv( ) function call, a thread-level environment variable is returned if it has been defined for the subject thread; otherwise it returns a corresponding process-level environment variable.

The invention is preferably implemented as part of a computer operating system. Such a software implementation contains logic in the form of a program of instructions that are executable by the hardware machine to perform the method steps of the invention. The program of instructions may be embodied on a program storage device comprising one or more volumes using semiconductor, magnetic, optical or other storage technology.

### BRIEF DESCRIPTION OF THE DRAWINGS

FIG. 1 shows an information handling system incorporating the present invention.

FIG. 2 shows the interaction between threads and environment variables as it exists in the prior art.

FIG. 3 shows the interaction between threads and environment variables as it exists in the present invention.

FIG. 4 shows the operation of the thread-level set functions of the present invention.

FIG. 5 shows the operation of the thread-level get function of the present invention.

### DESCRIPTION OF THE PREFERRED EMBODIMENT

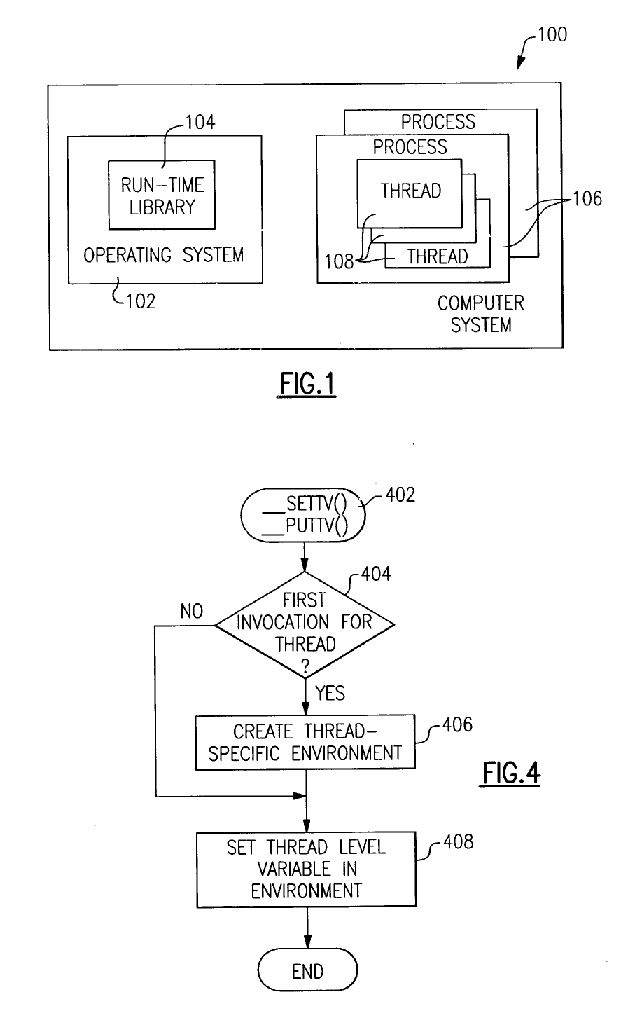

FIG. 1 shows an information handling system, specifically, a computer system 100, incorporating the present invention. As shown in the figure, the system 100 includes an operating system (OS) 102 that performs the usual functions of managing system resources and providing system services. OS 102 contains, among other elements not separately shown, a run-time library 104 containing various run-time functions, including those of the present invention. System 100 also includes one or more user processes 106, each of which has a plurality of simultaneously running threads of execution 108. OS 102 and user processes 106 run on a hardware machine containing the usual hardware elements including one or more central processing units (CPUs), main and secondary storage, and input/output (I/O) devices of various types. These hardware components function in an entirely conventional manner in the present invention, however, and are therefore not shown. Although the invention is not limited to any particular hardware or software platform, in the embodiment shown, operating system 102 is assumed to be a version of the IBM Z/OS™ operating system, running on an IBM zSeries™ server and containing a C/C++ run-time library 104. Run-time library 104 contains the various library functions described in the IBM C/C++ run-time library publication referenced above, as well as those of the present invention, as described below.

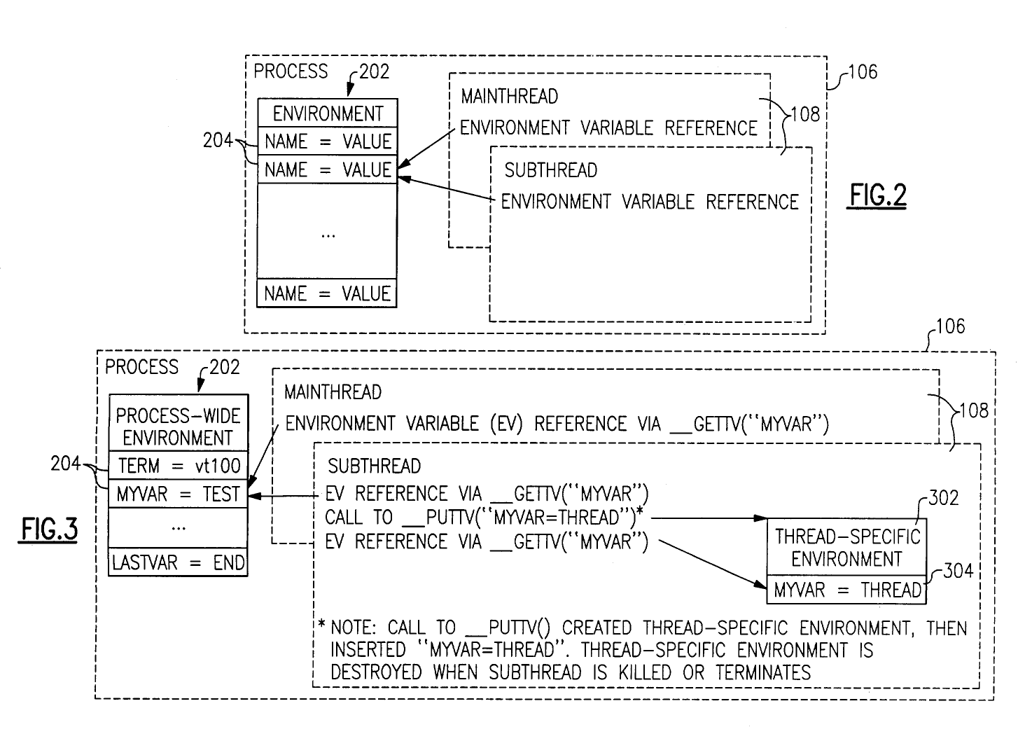

FIG. 2 shows a conventional implementation of environment variables for a process 106 containing multiple threads 108 (mainThread, subThread). As shown in the figure, a single data structure referred to herein as an environment 202 is created for the process 106. Environment 202 may contain specifications for one or more environment variables 204 consisting of strings “name=value”, where name is the name of an environment variable and value is its corresponding value. Each of these environment variables 204 is specified for the process 106 as a whole, regardless of which thread 108 created or modified the environment variable.

Environment variables 204 are conventionally manipulated using various existing functions of the run-time library 104, including most notably setenv( ), putenv( ), and getenv( ). As described in the referenced C/C++ run-time library publication, setenv( ) or putenv( ) is used to set a specified environment variable for the process of the caller to a specified value, while getenv( ) is used to obtain the value of a specified environment variable for the process of the caller. The function setenv( ) differs from putenv( ) by having a change flag as an additional input parameter. When the change flag is set to zero, a new entry for the specified environment variable is appended to the environment if there is no existing entry for the same variable; otherwise, the environment is not modified. When the change flag is set to other than zero, a new entry is likewise appended to the environment if there is no existing entry for the same variable; in this case, however, if there is an existing entry for the same variable, the new entry is written over the existing entry. The function putenv( ) does not have such a change flag, but always operates in the manner that setenv( ) would if its change flag were set to 1; i.e., it always overwrites a previous entry for the same environment variable.

To appreciate the restrictions of this conventional implementation, consider a fictitious environment variable, _SOME_BEHAVIOR, which a C/C++ programmer has set to equal BEHAVIOR_A in a parent thread main( ) using putenv( ). A child thread is then created from the parent thread main( ) via the function pthread_create( ), a standard function of the run-time library 104 that is described in the referenced run-time library publication. In a conventional implementation, the child thread also uses setenv( ) or putenv( ) if it wants to change the value of SOME_BEHAVIOR to BEHAVIOR_B. The undesired side-effect of this change is that future getenv( ) queries of _SOME_BEHAVIOR by the parent thread main( ) or any sibling threads now return BEHAVIOR_B.

In accordance with the present invention, the created thread is free to set _SOME_BEHAVIOR to BEHAVIOR_B using the functions of the present invention described below, with no effect on the results returned by any getenv( ) requests by the parent or siblings. The solution to these restrictions of process-wide environment variables entails newly defined functions for modifying and querying thread-specific environment variables and the maintenance of thread-specific environments.

More particularly, in accordance with the present invention, run-time library 104 contains three new thread-level functions: _settv( ), _uttv( ), and _gettv( ). These new functions have a syntax similar to that of setenv( ), putenv( ) and getenv( ), respectively, but operate on an environment variable defined at the level of the calling thread. Thus, _settv( ) or _uttv( ) is used to set a specified environment variable for the calling thread to a specified value, while _gettv( ) is used to obtain the value of a specified thread-level environment variable for the calling thread.

FIG. 3 shows an implementation for managing environment variables for a process 106 containing multiple threads 108 (mainThread, subThread) in accordance with the present invention. More particularly, FIG. 3 shows a process-wide environment 202 including, among others, the following process-level entries 204:

TERM=vt100

MYVAR=test

LASTVAR=end

In addition, however, FIG. 3 shows another data structure, a thread-specific environment 302 for a particular thread 108 (subThread), with a thread-level entry 304:

MYVAR=thread

In the scenario shown in FIG. 3, the first thread 108 (mainThread) does not have a thread-specific environment 302 defined for it. When it queries the environment variable MYVAR, using the function call _gettv(“MYVAR”) of the present invention, it gets back the value “test” defined for the process 106 as a whole. The second thread 108 (subThread), by contrast, makes the function call _puttv(“MYVAR=thread”) to create a thread-specific environment 302 and then insert a string 304 (“MYVAR=thread”) into this environment. When the second thread 108 then queries the environment variable MYVAR, using the function call _gettv(“MYVAR”) of the present invention, it gets back the value “thread” defined specifically for that thread 108 rather than the value defined for the process 106 as a whole.

Externally, two or three new library functions, =puttv( ) and/or _settv( ), and _gettv( ), are implemented as thread-specific versions of the existing process-wide functions putenv( ), setenv( ) and getenv( ). The _puttv( ) and/or _settv( ) function allows C programmers to set the value of an environment variable in a thread without the new setting being propagated to the thread's parent or siblings.

Internally, as before, one process-wide environment is initially made available to C programs.

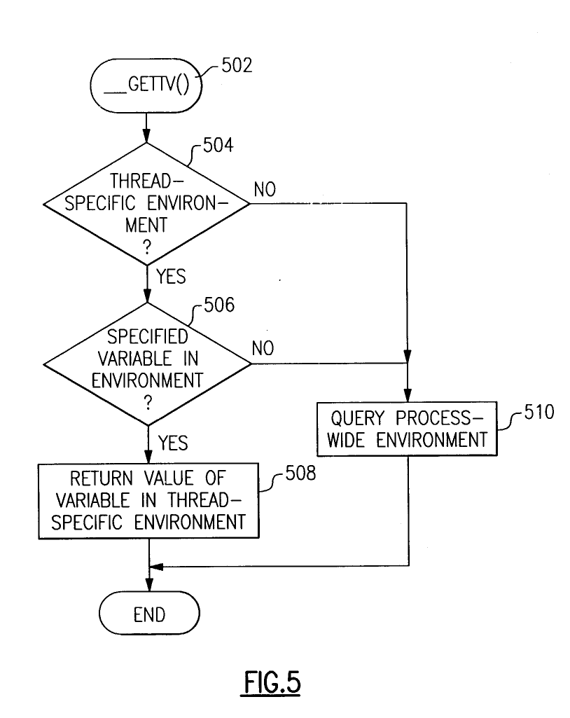

The use of putenv( ) and setenv( ) only affects the process-wide environment. The first use of _puttv( ) or _settv( ) in a particular thread initiates the creation of a thread-specific environment 302 for that thread, followed by the insertion of the specified “name=value” string into the thread-specific environment 302. Subsequent calls to _puttv( ) or _settv( ) simply insert or modify “name=value” strings in the already created thread-specific environment 302. Thus, referring to FIG. 4, upon being invoked (step 402), the _puttv( ) or _settv( ) function first determines whether this is the first invocation of either function for the particular thread 108 (step 404). If so, then the function creates a thread-specific environment 302 (step 406) and inserts the specified string 304 (step 408). If the thread-specific environment 302 has already been created, then the function simply adds or updates an existing string, as appropriate.

In a manner similar to the of the existing getenv( ) function, the _gettv( ) function of the present invention returns the value of a requested environment variable. However, _gettv( ) first determines whether the requested environment variable has a thread-level value, as set by an earlier call to _puttv( ) within the same thread. If the requested variable has been set via a call to _puttv( ), _gettv( ) returns the thread-specific value, otherwise _gettv( ) returns the process-wide environment variable.

FIG. 5 shows the operation of the thread-level get function _gettv( ) of the present invention.

Referring to this figure, upon being invoked (step 502), the _gettv( ) function first checks for the existence of a thread-specific environment 302 (step 504). If such an environment exists, _gettv( ) looks for the specified environment variable there (step 506). If the specified variable is in the thread-specific environment 302, _gettv( ) returns the value of the specified variable in the thread-specific environment 302 (step 508). If the specified variable is not in the thread-specific environment 302 or a thread-specific environment 302 does not exist, _gettv( ) queries the process-wide environment just as getenv( ) would and returns the process-wide value of the environment variable if that value has been set (step 510).

The thread-specific environment 302 that is created for a thread upon the setting of a first thread-specific variable for that thread remains in existence as long as the thread continues to run. Upon thread exit, the thread-specific environment 302 is destroyed if one exists.

While a particular embodiment has been shown and described, various modifications will be apparent to those skilled in the art. Thus, in the embodiment shown, the thread-level variables are manipulated by means of function calls issued by the subject thread itself. However, it is also possible to manipulate such thread variables by means of a user command that is similar to the existing env( ) command, but is directed to the environment variable at the thread level. Still other modifications will be apparent to those skilled in the art.

What is claimed is:

1. In an information handling system having a plurality of simultaneously running threads of execution of a user process, a method for managing environment variables in said user process, comprising the steps of:
storing for each of one or more of said threads a thread-level environment variable defined for the thread, said thread-level environment variable being capable of having a different value for different threads of said user process; and
accessing a thread-level environment variable of a subject thread in response to a request to access said thread-level environment variable of said subject thread.

2. The method of claim 1 in which the request originates from said subject thread.

3. The method of claim 1 in which the request specifies a name of a thread-level environment variable.

4. The method of claim 1 in which the request specifies a name of a thread-level environment variable and a value for said thread-level environment variable.

5. The method of claim 1 in which said request is a request to set the value of said thread-level environment variable.

6. The method of claim 5 in which said accessing step comprises the step of:
determining whether a thread-specific environment has already been created for the subject thread;
inserting said thread-level environment variable in said thread-specific environment if said thread-specific environment has already been created for the subject thread; and
creating a thread-specific environment and inserting said thread-level environment variable in said thread-specific environment if said thread-specific environment has not already been created for the subject thread.

7. The method of claim 1 in which said request is a request to obtain the value of said thread-level environment variable.

8. The method of claim 7 in which said accessing step comprises the steps of:
determining whether a thread-level environment variable has been defined for the subject thread;
returning a thread-level environment variable if the thread-level environment variable has been defined for the subject thread, and returning a corresponding process-level environment variable if a thread-level environment variable has not been defined for the subject thread.

9. The method of claim 1 in which said thread-level environment variable is stored in a thread-specific environment created for the subject thread.

10. The method of claim 9 in which said thread-specific environment is destroyed upon termination of said subject thread.

11. A program storage device readable by a machine, tangibly embodying a program of instructions executable by the machine to perform method steps for managing environment variables in a user process in an information handling system having a plurality of simultaneously running threads of execution, said method steps comprising:
storing for each of one or more of said threads a thread-level environment variable defined for the thread, said thread-level environment variable being capable of having a different value for different threads of said user process; and
accessing a thread-level environment variable of a subject thread in response to a request to access said thread-level environment variable of said subject thread.

12. The program storage device of claim 11 in which the request originates from said subject thread.

13. The program storage device of claim 111 in which said request is a request to set the value of said thread-level environment variable, said accessing step comprising the step of:
determining whether a thread-specific environment has already been created for the subject thread;
inserting said thread-level environment variable in said thread-specific environment if said thread-specific environment has already been created for the subject thread; and
creating a thread-specific environment and inserting said thread-level environment variable in said thread-specific environment if said thread-specific environment has not already been created for the subject thread.

14. The program storage device of claim 11 in which said request is a request to obtain the value of said thread-level environment variable, said accessing step comprising the steps of:
determining whether a thread-level environment variable has been defined for the subject thread;
returning a thread-level environment variable if the thread-level environment variable has been defined for the subject thread, and returning a corresponding process-level environment variable if a thread-level environment variable has not been defined for the subject thread.

15. The program storage device of claim 1 in which said thread-level environment variable is stored in a thread-level environment created for the subject thread that is destroyed upon termination of said subject thread.

16. In an information handling system having a plurality of simultaneously running threads of execution of a user process, apparatus for managing environment variables in said user process, comprising:
logic for storing for each of one or more of said threads a thread-level environment variable defined for the thread, said thread-level environment variable being capable of having a different value for different threads of said user process; and
an access function responsive to a request to access a thread-level environment variable of a subject thread for accessing said thread-level environment variable of said subject thread.

17. The apparatus of claim 16 in which the request originates from said subject thread.

18. The apparatus of claim 16 in which said request is a request to set the value of said thread-level environment variable, said access function comprising:
logic for determining whether a thread-specific environment has already been created for the subject thread;
logic for inserting said thread-level environment variable in said thread-specific environment if said thread-specific environment has already been created for the subject thread; and
logic for creating a thread-specific environment and inserting said thread-level environment variable in said thread-specific environment if said thread-specific environment has not already been created for the subject thread.

19. The apparatus of claim 16 in which said request is a request to obtain the value of said thread-level environment variable, said access function comprising:
logic for determining whether a thread-level environment variable has been defined for the subject thread;
logic for returning a thread-level environment variable if the thread-level environment variable has been defined for the subject thread, and
logic for returning a corresponding process-level environment variable if a thread-level environment variable has not been defined for the subject thread.

20. The apparatus of claim 16 in which said thread-level environment variable is stored in a thread-specific environment created for the subject thread that is destroyed upon termination of said subject thread.
